(19) United States
(12) Patent Application Publication
(10) Pub. No.: US 2026/0072810 A1
(43) Pub. Date: Mar. 12, 2026

(54) UNIT TEST BENCHMARKING DATASET GENERATION AND USE

(71) Applicant: NUTANIX, INC., San Jose, CA (US)

(72) Inventors: Rajat GHOSH, San Jose, CA (US); Vaishnavi BHARGAVA, Madison, WI (US); Debojyoti DUTTA, Santa Clara, CA (US)

(21) Appl. No.: 19/090,010

(22) Filed: Mar. 25, 2025

Related U.S. Application Data
(60) Provisional application No. 63/693,620, filed on Sep. 11, 2024.

(51) Int. Cl. G06F 11/3668; G06N 3/0895

(52) U.S. Cl. CPC G06F 11/3668; G06N 3/0895

(57) ABSTRACT

Techniques for unit test benchmarking dataset generation and use include performing steps comprising retrieving source code and test code from a codebase; extracting, using a large language model, a plurality of methods from the source code; extracting, using a large language model, a plurality of unit test functions from the test code; generating a test entry that relates a respective method signature of a plurality of method signatures to one or more unit test signatures of a plurality of unit test signatures; and storing the test entry in a unit test benchmark dataset, the test entry comprising a method of the plurality of methods and one or more unit test functions of the plurality of unit test functions, wherein the method corresponds to the respective method signature and the one or more unit test functions correspond to the one or more unit test signatures.

### CROSS-REFERENCE TO RELATED APPLICATIONS

This application claims priority benefit of the United States Provisional Patent Application titled, “C++ UNIT TEST BENCHMARKING DATASET,” filed on Sep. 11, 2024, and having Ser. No. 63/693,620. The subject matter of this related application is hereby incorporated herein by reference.

### BACKGROUND

### Field of the Various Embodiments

Embodiments of the present invention relate generally to software development tasks and more specifically to unit test benchmarking dataset generation and use.

### DESCRIPTION OF THE RELATED ART

Large Language Models (LLMs) are trained on a large corpus of data in order to be effective in distilling knowledge and performing other tasks effectively for a wide set of domains. An LLM can also be specialized using domain adaptive training, fine-tuning or instruction tuning.

Unit testing can refer to testing the efficacy of units or portions of code, such as one or more functions or methods. Unit tests are generally developed by software developers in order to test source code to help ensure that the source code operates correctly and addresses all the corner and edge cases. In many cases, the unit tests are generated manually by the software developers.

The are many coding benchmarks and tool suites that automate various software coding tasks that can reduce the manual effort needed to develop and test source code. For example, the Mostly Basic Python Programming (MPBB) benchmark covers many coding tasks but does not cover all coding tasks including unit test generation. Other unit test generation systems are available for various programming languages. However, C and C++ are known to have a higher Kolmogorov complexity and a higher cyclomatic complexity due to the verbosity of C and C++, the use of advanced coding features (e.g., templates, macros), and use of manual memory management. As a result, existing unit test generation systems are not able to generate unit tests for C and C++ code.

Many source code repositories are available (e.g., github) that include numerous examples of C and C++ source code along with unit tests. However, these source code repositories often include poor coverage of unit tests for the source code in the source code repositories. In addition, the source code repositories often include poor documentation describing the relationships between functions/methods and the corresponding unit test. As a result it is often difficult to identify good examples of unit tests from source code repositories using conventional tools.

Codebases can include code as well as unit tests for various portions of the code. The unit tests can be time consuming to generate, and time-consuming to test. Unit tests can also be generated manually by developers and procedurally using rules-based unit test generation programs. Test generation programs and methods can avoid some manual development, but these processes can nevertheless require manual oversight to ensure efficacy.

As a result there is a need for more effective unit test generation processes, especially for C++ source code.

### SUMMARY

The disclosed embodiments describe techniques for generating an effective unit test benchmarking and training dataset for training an LLM to generate unit tests for source code. The unit test benchmark dataset is automatically or programmatically generated from a codebase containing source code and test code. The unit test benchmark dataset is programmatically generated to include training-relevant data from the complete codebase. The automatically generated unit test benchmark dataset is then usable retrain a pretrained LLM to generate unit tests for given source code. The generated unit tests can then be used to test the given source code.

In various embodiments, a computer-implemented method, retrieving source code and test code from a codebase; extracting, using a large language model, a plurality of methods from the source code; extracting, using a large language model, a plurality of unit test functions from the test code; generating a test entry that relates a respective method signature of a plurality of method signatures to one or more unit test signatures of a plurality of unit test signatures; and storing the test entry in a unit test benchmark dataset, the test entry comprising a method of the plurality of methods and one or more unit test functions of the plurality of unit test functions, wherein the method corresponds to the respective method signature and the one or more unit test functions correspond to the one or more unit test signatures.

Further embodiments provide, among other things, one or more non-transitory computer-readable media storing instructions and systems for implementing one or more aspects of the disclosed techniques.

At least one technical advantage of the disclosed techniques relative to prior art is that, with the disclosed techniques, benchmark unit test dataset generation, such as for C++, is automated. The disclosed techniques also improve the ability of LLMs to generate unit tests for C++ source code while also reducing time, processing, and energy resources for training large language models that generate unit tests for C++. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIGS. 1A-1D are block diagrams illustrating virtualization system architectures configured to implement one or more aspects of the present embodiments.

FIG. 2 is a block diagram illustrating a computing environment configured to implement one or more aspects of the present embodiments.

FIG. 3 sets forth a flow diagram of method steps for generating a C++ benchmarking data set, according to various embodiments.

FIG. 4 sets forth a flow diagram of method steps for training an LLM using a C++ benchmarking dataset, according to various embodiments.

FIG. 5 sets forth a flow diagram of method steps for generating unit test using a trained unit test generating LLM, according to various embodiments.

FIG. 6 depicts an example of an LLM prompt template usable to generate unit tests using a trained unit test generating LLM, according to various embodiments.

### DETAILED DESCRIPTION

In the following description, various concepts and examples are disclosed that provide more effective techniques for accessing business data using executable code included in authorization identifiers. The numerous specific details set forth will provide artisans with a more thorough understanding of the various embodiments. However, it will be apparent to one skilled in the art that the inventive concepts can be practiced without one or more of these specific details.

### Exemplary Virtualization System Architectures

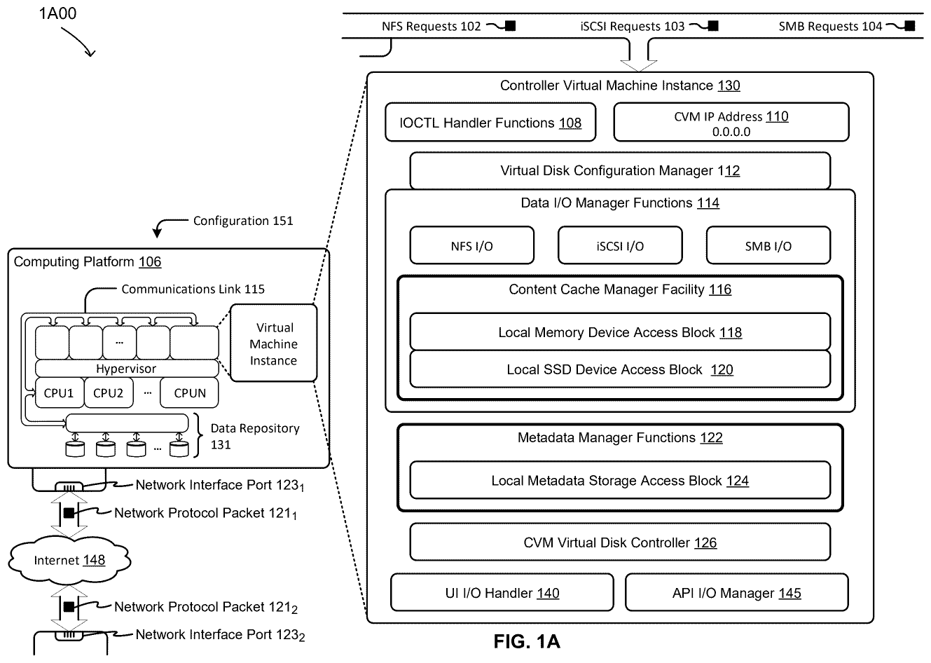

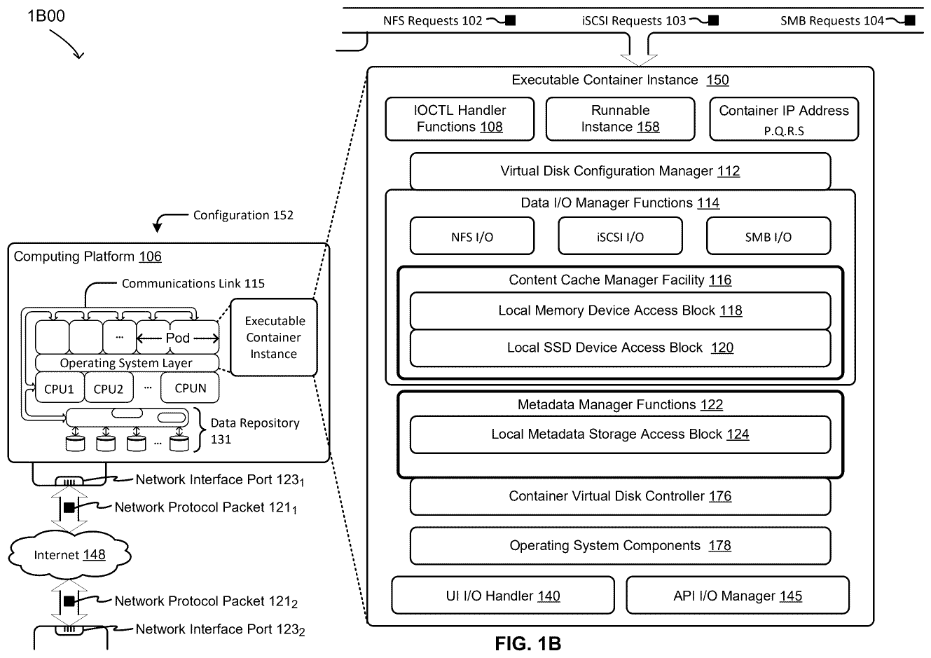

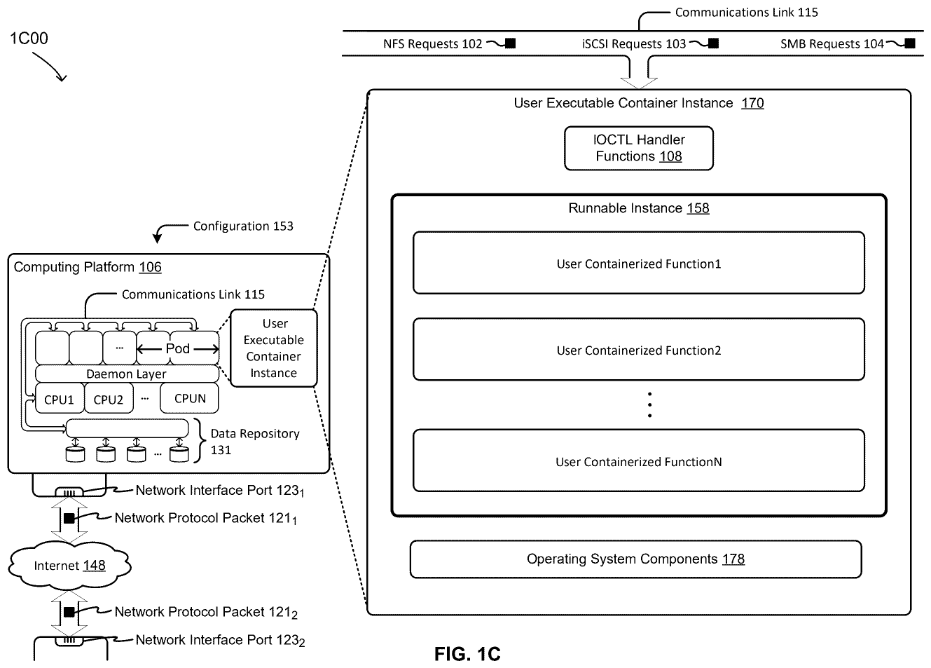

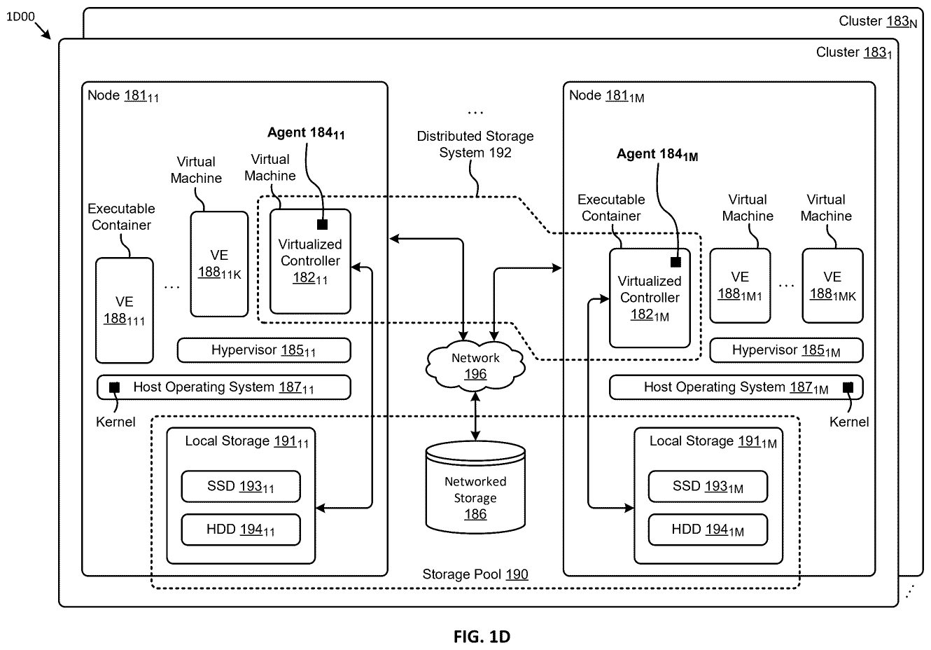

According to some embodiments, all or portions of any of the disclosed techniques can be partitioned into one or more modules and instances within, or as, or in conjunction with a virtualized controller in a virtual computing environment. Some example instances within various virtual computing environments are shown and discussed in further detail in FIGS. 1A-1D. Consistent with these embodiments, a virtualized controller includes a collection of software instructions that serve to abstract details of underlying hardware or software components from one or more higher-level processing entities. In some embodiments, a virtualized controller can be implemented as a virtual machine, as an executable container, or within a layer (e.g., such as a layer in a hypervisor). Consistent with these embodiments, distributed systems include collections of interconnected components that are designed for, or dedicated to, storage operations as well as being designed for, or dedicated to, computing and/or networking operations.

In some embodiments, interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

In some embodiments, a hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

In some embodiments, physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

FIG. 1A is a block diagram illustrating virtualization system architecture 1A00 configured to implement one or more aspects of the present embodiments. As shown in FIG. 1A, virtualization system architecture 1A00 includes a collection of interconnected components, including a controller virtual machine (CVM) instance 130 in a configuration 151. Configuration 151 includes a computing platform 106 that supports virtual machine instances that are deployed as user virtual machines, or controller virtual machines or both. Such virtual machines interface with a hypervisor (as shown). In some examples, virtual machines can include processing of storage I/O (input/output or IO) as received from any or every source within the computing platform. An example implementation of such a virtual machine that processes storage I/O is depicted as CVM instance 130.

In this and other configurations, a CVM instance receives block I/O storage requests as network file system (NFS) requests in the form of NFS requests 102, internet small computer storage interface (ISCSI) block IO requests in the form of iSCSI requests 103, Samba file system (SMB) requests in the form of SMB requests 104, and/or the like. The CVM instance publishes and responds to an internet protocol (IP) address (e.g., CVM IP address 110). Various forms of input and output can be handled by one or more IO control handler functions (e.g., IOCTL handler functions 108) that interface to other functions such as data IO manager functions 114 and/or metadata manager functions 122. As shown, the data IO manager functions can include communication with virtual disk configuration manager 112 and/or can include direct or indirect communication with any of various block IO functions (e.g., NFS IO, ISCSI IO, SMB IO, etc.).

In addition to block IO functions, configuration 151 supports IO of any form (e.g., block IO, streaming IO, packet-based IO, HTTP traffic, etc.) through either or both of a user interface (UI) handler such as UI IO handler 140 and/or through any of a range of application programming interfaces (APIs), possibly through API IO manager 145.

Communications link 115 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), formatting of bit fields into fixed-length blocks or into variable length fields used to populate the payload, and/or the like. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry can be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

Computing platform 106 includes one or more computer readable media that is capable of providing instructions to a data processor for execution. In some examples, each of the computer readable media can take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random-access persistent memories (RAPMs) or optical or magnetic media drives such as paper tape or magnetic tape drives. Volatile media includes dynamic memory such as random-access memory (RAM). As shown, controller virtual machine instance 130 includes content cache manager facility 116 that accesses storage locations, possibly including local dynamic random-access memory (DRAM) (e.g., through local memory device access block 118) and/or possibly including accesses to local solid-state storage (e.g., through local SSD device access block 120).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 131, which in turn can be formatted into any one or more storage areas, and which can comprise parameterized storage accessible by a key (e.g., a filename, a table name, a block address, an offset address, etc.). Data repository 131 can store any forms of data and can comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 124. The data repository 131 can be configured using CVM virtual disk controller 126, which can in turn manage any number or any configuration of virtual disks.

Execution of a sequence of instructions to practice certain of the disclosed embodiments is performed by one or more instances of a software instruction processor, or a processing element such as a data processor, or such as a central processing unit (e.g., CPU1, CPU2, . . . , CPUN). According to certain embodiments of the disclosure, two or more instances of configuration 151 can be coupled by communications link 115 (e.g., backplane, LAN, PSTN, wired or wireless network, etc.) and each instance can perform respective portions of sequences of instructions as can be required to practice embodiments of the disclosure.

The shown computing platform 106 is interconnected to the Internet 148 through one or more network interface ports (e.g., network interface port 1231 and network interface port 1232). Configuration 151 can be addressed through one or more network interface ports using an IP address. Any operational element within computing platform 106 can perform sending and receiving operations using any of a range of network protocols, possibly including network protocols that send and receive packets (e.g., network protocol packet 1211 and network protocol packet 1212).

Computing platform 106 can transmit and receive messages that can be composed of configuration data and/or any other forms of data and/or instructions organized into a data structure (e.g., communications packets). In some cases, the data structure includes program instructions (e.g., application code) communicated through the Internet 148 and/or through any one or more instances of communications link 115. Received program instructions can be processed and/or executed by a CPU as it is received and/or program instructions can be stored in any volatile or non-volatile storage for later execution. Program instructions can be transmitted via an upload (e.g., an upload from an access device over the Internet 148 to computing platform 106). Further, program instructions and/or the results of executing program instructions can be delivered to a particular user via a download (e.g., a download from computing platform 106 over the Internet 148 to an access device).

Configuration 151 is merely one example configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

In some embodiments, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to management of block stores. Various implementations of the data repository comprise storage media organized to hold a series of records and/or data structures.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT,” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT,” issued on Oct. 1, 2013, which is hereby incorporated by reference in its entirety.

FIG. 1B depicts a block diagram illustrating another virtualization system architecture 1B00 configured to implement one or more aspects of the present embodiments. As shown in FIG. 1B, virtualization system architecture 1B00 includes a collection of interconnected components, including an executable container instance 150 in a configuration 152. Configuration 152 includes a computing platform 106 that supports an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification (e.g., “http:”) and possibly handling port-specific functions. In some embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node can communicate directly with storage devices on the second node.

The operating system layer can perform port forwarding to any executable container (e.g., executable container instance 150). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and can include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “Is” or “Is -a”, etc.). The executable container might optionally include operating system components 178, however such a separate set of operating system components need not be provided. As an alternative, an executable container can include runnable instance 158, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 176. Such a container virtual disk controller can perform any of the functions that the aforementioned CVM virtual disk controller 126 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 1C is a block diagram illustrating virtualization system architecture 1C00 configured to implement one or more aspects of the present embodiments. As shown in FIG. 1C, virtualization system architecture 1C00 includes a collection of interconnected components, including a user executable container instance in configuration 153 that is further described as pertaining to user executable container instance 170. Configuration 153 includes a daemon layer (as shown) that performs certain functions of an operating system.

User executable container instance 170 comprises any number of user containerized functions (e.g., user containerized function1, user containerized function2, . . . , user containerized functionN). Such user containerized functions can execute autonomously or can be interfaced with or wrapped in a runnable object to create a runnable instance (e.g., runnable instance 158). In some cases, the shown operating system components 178 comprise portions of an operating system, which portions are interfaced with or included in the runnable instance and/or any user containerized functions. In some embodiments of a daemon-assisted containerized architecture, computing platform 106 might or might not host operating system components other than operating system components 178. More specifically, the shown daemon might or might not host operating system components other than operating system components 178 of user executable container instance 170.

In some embodiments, the virtualization system architecture 1A00, 1B00, and/or 1C00 can be used in any combination to implement a distributed platform that contains multiple servers and/or nodes that manage multiple tiers of storage where the tiers of storage might be formed using the shown data repository 131 and/or any forms of network accessible storage. As such, the multiple tiers of storage can include storage that is accessible over communications link 115. Such network accessible storage can include cloud storage or networked storage (e.g., a SAN or storage area network). Unlike prior approaches, the disclosed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In some embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

In some embodiments, any one or more of the aforementioned virtual disks can be structured from any one or more of the storage devices in the storage pool. In some embodiments, a virtual disk is a storage abstraction that is exposed by a controller virtual machine or container to be used by another virtual machine or container. In some embodiments, the virtual disk is exposed by operation of a storage protocol such as iSCSI or NFS or SMB. In some embodiments, a virtual disk is mountable. In some embodiments, a virtual disk is mounted as a virtual storage device.

In some embodiments, some or all of the servers or nodes run virtualization software. Such virtualization software might include a hypervisor (e.g., as shown in configuration 151) to manage the interactions between the underlying hardware and user virtual machines or containers that run client software.

Distinct from user virtual machines or user executable containers, a special controller virtual machine (e.g., as depicted by controller virtual machine instance 130) or as a special controller executable container is used to manage certain storage and I/O activities. Such a special controller virtual machine is sometimes referred to as a controller executable container, a service virtual machine (SVM), a service executable container, or a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines-above the hypervisors-thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 1D is a block diagram illustrating virtualization system architecture 1D00 configured to implement one or more aspects of the present embodiments. As shown in FIG. 1D, virtualization system architecture 1D00 includes a distributed virtualization system that includes multiple clusters (e.g., cluster 183₁, . . . , cluster 183_{N}) comprising multiple nodes that have multiple tiers of storage in a storage pool. Representative nodes (e.g., node 181₁₁, . . . , node 181_{1M}) and storage pool 190 associated with cluster 183₁ are shown. Each node can be associated with one server, multiple servers, or portions of a server. The nodes can be associated (e.g., logically and/or physically) with the clusters. As shown, the multiple tiers of storage include storage that is accessible through a network 196, such as a networked storage 186 (e.g., a storage area network or SAN, network attached storage or NAS, etc.). The multiple tiers of storage further include instances of local storage (e.g., local storage 191₁₁, . . . , local storage 191_{1M}). For example, the local storage can be within or directly attached to a server and/or appliance associated with the nodes. Such local storage can include solid state drives (SSD 193₁₁, . . . , SSD 193_{1M}), hard disk drives (HDD 194₁₁, . . . , HDD 194_{1M}), and/or other storage devices.

As shown, any of the nodes of the distributed virtualization system can implement one or more user virtualized entities (e.g., VE 188¹¹¹, . . . , VE 188^{11K}, . . . , VE 188^{1M1}, . . . , VE 188^{1MK}), such as virtual machines (VMs) and/or executable containers. The VMs can be characterized as software-based computing “machines” implemented in a container-based or hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 187¹¹, . . . , host operating system 187^{1M}), while the VMs run multiple applications on various respective guest operating systems. Such flexibility can be facilitated at least in part by a hypervisor (e.g., hypervisor 185¹¹, . . . , hypervisor 185^{1M}), which hypervisor is logically located between the various guest operating systems of the VMs and the host operating system of the physical infrastructure (e.g., node).

As an alternative, executable containers can be implemented at the nodes in an operating system-based virtualization environment or in a containerized virtualization environment. The executable containers are implemented at the nodes in an operating system virtualization environment or container virtualization environment. The executable containers can include groups of processes and/or resources (e.g., memory, CPU, disk, etc.) that are isolated from the node host computer and other containers. Such executable containers directly interface with the kernel of the host operating system (e.g., host operating system 187₁₁, . . . , host operating system 187_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 190 by the VMs and/or the executable containers.

Multiple instances of such virtualized controllers can coordinate within a cluster to form the distributed storage system 192 which can, among other operations, manage the storage pool 190. This architecture further facilitates efficient scaling in multiple dimensions (e.g., in a dimension of computing power, in a dimension of storage space, in a dimension of network bandwidth, etc.).

In some embodiments, a particularly configured instance of a virtual machine at a given node can be used as a virtualized controller in a hypervisor-assisted virtualization environment to manage storage and I/O (input/output or IO) activities of any number or form of virtualized entities. For example, the virtualized entities at node 181₁₁ can interface with a controller virtual machine (e.g., virtualized controller 182₁₁) through hypervisor 185₁₁ to access data of storage pool 190. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 192. For example, a hypervisor at one node in the distributed storage system 192 might correspond to software from a first vendor, and a hypervisor at another node in the distributed storage system 192 might correspond to a second software vendor. As another virtualized controller implementation example, executable containers can be used to implement a virtualized controller (e.g., virtualized controller 182_{1M}) in an operating system virtualization environment at a given node. In this case, for example, the virtualized entities at node 181_{1M} can access the storage pool 190 by interfacing with a controller container (e.g., virtualized controller 182_{1M}) through hypervisor 185_{1M} and/or the kernel of host operating system 187_{1M}.

In some embodiments, one or more instances of an agent can be implemented in the distributed storage system 192 to facilitate the herein disclosed techniques. Specifically, agent 184₁₁ can be implemented in the virtualized controller 182₁₁, and agent 184_{1M} can be implemented in the virtualized controller 182_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or the agents.

### C++ Unit Test Benchmarking Dataset Generation and Use

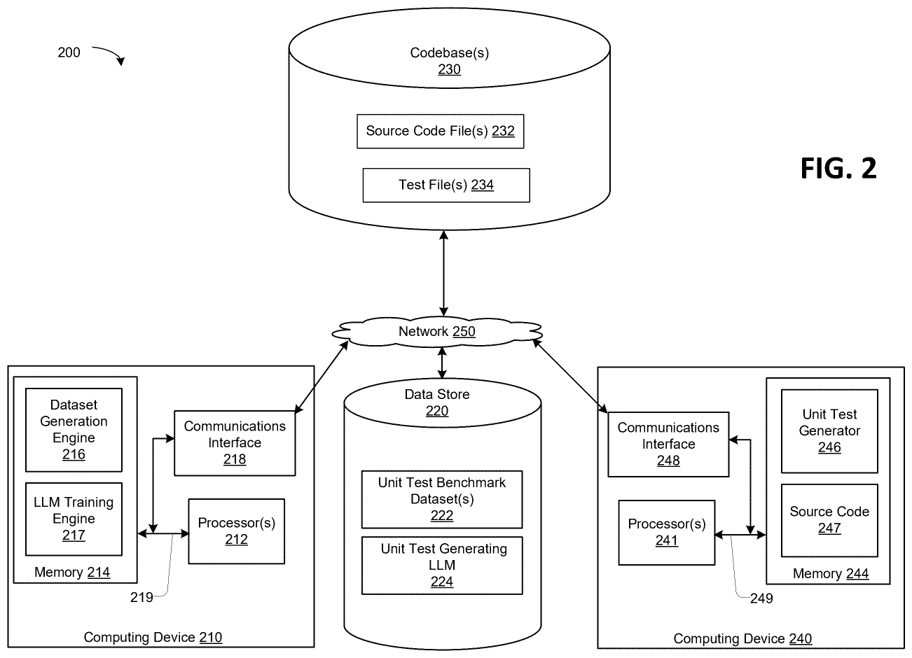

FIG. 2 is a block diagram illustrating a computing environment 200 configured to implement one or more aspects of the present embodiments. As shown, the computing environment 200 includes, without limitation, a computing device 210, a data store 220, one or more codebases 230, a computing device 240, and a network 250. Computing device 210 includes, without limitation, one or more processors 212, memory 214, a communications interface 218, and a bus 219. Memory 214 includes, without limitation, a dataset generation engine 216 and an LLM training engine 217. Data store 220 includes one or more unit test benchmark datasets 222 and a unit test generating LLM 224. Each of the one or more codebases 230 include, without limitation, one or more source code files 232 and one or more test files 234. Computing device 240 includes, without limitation, one or more processors 242, memory 244, a communications interface 248, and a bus 249. Memory 244 includes, without limitation, unit test generator 246 and source code 247.

Computing environment 200 described herein is illustrative and any other technically feasible configurations fall within the scope of the present disclosure. For example, dataset generation engine 216 and LLM training engine 217 can be located and executed in different computing devices. The one or more unit test benchmark datasets 222 can be located in a different datastore than the unit test generating LLM 224. Further, in the context of this disclosure, any of the computing elements shown in the computing environment 200 can correspond to a physical computing system (e.g., a system in a data center) or can include a virtual computing instance. In various embodiments, the components of the computing environment 200 can be included in any combination of the virtualization system architectures shown in FIGS. 1A-1D.

The one or more processors 212 include any suitable processors implemented as a central processing unit (CPU), a graphics processing unit (GPU), an application-specific integrated circuit (ASIC), a field programmable gate array (FPGA), an artificial intelligence (AI) accelerator, any other type of processor, or a combination of different processors, such as a CPU configured to operate in conjunction with a GPU. In general, the one or more processors 212 can be any technically feasible hardware unit capable of processing data and/or executing software applications.

Memory 214 includes a random-access memory (RAM) module, a flash memory unit, and/or any other type of memory unit or combination thereof. The one or more processors 212 and/or communications interface 218 are configured to read data from and write data to memory 214. Memory 214 can further include additional types of storage Memory 214 can further include additional types of storage including, but not limited to. one or more fixed or removable disk drives, HDDs, SSD, NVMes, vDisks, flash memory devices, and/or other magnetic, optical, and/or solid-state storage devices. Memory 214 includes various software programs that include one or more instructions that can be executed by the one or more processors 212 and application data associated with those software programs. As shown, memory 214 includes dataset generation engine 216 and LLM training engine 217.

Communications interface 218 includes any technically feasible interface for coupling computing device 210 and the one more processors 212 with network 250. Communications interface 218 can include one more hardware or software components. For example, communications interface can provide an interface that is compliant with one or more wired or wireless Ethernet standards, and/or the like.

Bus 219 interconnects subsystems and devices within computing device 210, such as the one or more processors 212, memory 214, and communications interface 218. Bus 219 can include one more parallel or serial buses.

Dataset generation engine 216 generates unit test benchmark dataset 222 for storage in data store 220 for access by other applications and/or the like. In operation, dataset generation engine 216 retrieves data from one or more of the codebases 230. The dataset generation engine 216 uses application programming interface (API) calls and/or other programmatic calls to retrieve the data from the one or more codebases 230. Dataset generation engine 216 retrieves data from the one or more codebases 230 as one or more source code files based on the file extensions of the files. For example, dataset generation application 216 can retrieve source code files written in C++ by searching for files having an extension of .cc, .cpp, .CPP, .cxx, .cp, .c++, .h, and/or the like. In addition, dataset generation engine 216 retrieves unit test files based on the file extensions. For example, dataset generation application 216 can retrieve unit test files by searching for files having an extension of _test.cc, _unittest.cc, and/or the like. Dataset generation application 216 can further search an entire directory tree of a codebase 230 by recursively traversing the directory tree of the codebase 230.

Once dataset generation application 216 has retrieved the source code and unit test files from the codebase 230, dataset generation application 216 groups the retrieved files by their base name. For example, dataset generation application 216 would group the files foo.cc and foo_unittest.cc) together for having a shared base name of “foo.” Dataset generation application 216 then generates a test entry capturing the relationship between the source code file in each group and the test file. In some embodiments, when a group has both a test file (e.g., _test.cc) and a unit test file (e.g., _unittest.cc), the test entry is created between the source code file and the test file. The test entry includes information about the various files and is stored in a corresponding unit test benchmark dataset 222 for the codebase or a group of codebases. The test entry corresponds to an example of training data for generating unit test code for the source code. In some embodiments, the mapping includes, without limitation, an ID (e.g., a unique number), a language (e.g., C++), a repository name (e.g., a name of the codebase 230, such “example/exampletest”), a file name (e.g., foo indicating the base name), a file path for the source code (e.g., “exampletest/samples/foo.cc”), a file path for the test code (e.g., “exampletest/samples/foo_unittest.cc”), the source code from the source code file, and the test source code from the test file (e.g., a ground truth example of test source code for the source code from the source code file). In some examples, all the documentation and comments are removed from the source code to reduce the size of the test entry and the corresponding unit test benchmark dataset 222.

In cases where a unit test benchmark dataset 222 is to be used to train an LLM with a context limit (e.g., 8k) that is too small to handle training data with large source code blocks or large test code blocks, the test entries in the unit test benchmark dataset 222 can be further refined to identify tests at the method or function level. In such cases, dataset generation application 216 can store the additional test entries in a same unit test benchmark dataset 222 or in a separate unit test benchmark dataset for training LLMs with smaller context limits. Dataset generation application 216 begins by identifying each of the methods/functions in the source code file, such as each of the constructors, destructors, member functions, overloaded operators, and/or the like. The signature of each of the methods/functions is then determined and the source code for each of the methods/functions is extracted from the source code file. In some embodiments, dataset generation application 216 can provide a structured prompt and the source code to an LLM to identify the methods/functions. Dataset generation application 216 then identifies, for each of the methods/functions identified in the source code file, each of the places in the corresponding test files that invoke the method/function. The signature of each of the test functions in the test file that invoke the method/function is then determined and the source code of the test function is extracted from the test file. In some embodiments, dataset generation application 216 can provide a structured prompt and the test file to an LLM to identify the test functions. In some embodiments, analysis of the test file focuses on TEST and TEST_F macros.

Dataset generation application 216 then generates test entries for each of the methods/functions and the corresponding test functions for storage in one or more of the unit test benchmark datasets 222. When a method/function has multiple corresponding test functions, the test entry will identify each of the test functions. In addition, because a test function might invoke more than one method/function, a given test function might be included in multiple test entries. Each test entry includes, without limitation, an identifier of the method/function (e.g., the signature of the method/function) and source code for the method/function, and a list including an identifier of each corresponding test function (e.g., the signature of the test function), and the source code of each corresponding test function. In some examples, the identifier for the method/function can act as a key for the record with the value field including the source code of the method/function and the list with the identifier and source code for each of the corresponding test functions. In some examples, all the documentation and comments are removed from the source code for the method/function to reduce the size of the test entry and the corresponding unit test benchmark dataset 222.

LLM training engine 217 uses the one or more unit test benchmark datasets 222 to further train a pretrained LLM. In some cases, the further training is a form of alignment training for the pretrained LLM. The pretrained LLM can be any technically suitable LLM, such as any of the Llama, Mistral, Phi, and/or similar families of LLMs. In some embodiments, LLM training engine 217 selects from the one or unit test benchmark datasets 222 based on a context limit of the pretrained LLM. Once the pretrained LLM is retrained, LLM training engine 217 saves the LLM as unit test generating LLM 224.

LLM training engine 217 can use any technically feasible training approach to retrain the pretrained LLM to generate unit test generating LLM 224. For example, LLM training engine 217 can use any of few-shot in-context learning (FS-ICL), parameter efficient fine-tuning (PEFT), full-parameter fine-tuning (FPFT), and/or the like.

When using FS-ICL, LLM training engine 217 provides a few examples of the unit test generation task (e.g. example of unit tests that are the ground truth for some input source code) and uses the examples as conditioning, but without updating any weights of the pretrained LLM. FS-ICL takes a query, xₜₑₛₜ at inference time and uses a fixed-parameter model, f_{θ}, along with k demonstrations, (xᵢ, yᵢ) for i=1 to k of source code and unit test to produce a response yₜₑₛₜ corresponding to a unit test for the source code. The response quality depends on the pretrained LLM f_{θ} and the demonstration set according to Equation 1.

$${y}_{test} = {f}_{θ} ( {\{ ( {x}_{i} , {y}_{i} ) \}}_{i = 1}^{k} , {x}_{test} ) \qquad Equation 1$$

When using PEFT, LLM training engine 217 updates a subset of the weights of the pretrained LLM f_{θ} by training on a supervised dataset specific to the desired task of generating unit tests. In some examples, at least a few thousands labeled unit test generation examples (e.g., test entries) are used. In some examples, PEFT uses low-rank adaptation (LoRA) according to Equation 2.

$$\begin{matrix}max \\ θ\end{matrix} {\sum }_{( x , y ) ϵ Z} {\sum }_{t = 1}^{\vert y \vert} log ( {P}_{Φ0} + ΔΦ ( θ ) ( {y}_{t} \vert x , y < t ) ) \qquad Equation 2$$

When using FPFT, LLM training engine 217 updates all the weights of the pretrained LLM f_{θ}, which has a higher computational cost than PEFT/LoRA, using Equation 3.

$$\begin{matrix}max \\ Φ\end{matrix} {\sum }_{( x , y ) ϵ Z} {\sum }_{t = 1}^{\vert y \vert} log ( {P}_{Φ0} + ΔΦ ( θ ) ( {y}_{t} \vert x , y < t ) ) \qquad Equation 2$$

In both PEFT and FPFT, the pretrained LLM is parameterized by φ. A downstream task is represented by a training dataset of context-target (e.g., source code, unit test) pairs Z={(xᵢ, yᵢ)}i=1, . . . ,N where both xᵢ and yᵢ are sequences of source code tokens. During FPFT, the pretrained LLM is initialized to the base weights φ₀ and updated to φ₀+Δφ by repeatedly following the gradient to maximize the conditional unit test generation objective as shown in Equation 3.

Data store 220 can include any storage device or devices, such as fixed disc drive(s), flash drive(s), optical storage, network attached storage (NAS), and/or a storage area-network (SAN). Although shown as accessible over network 250, in some embodiments computing device 210 can include data store 220. As shown, data store 220 is storing, without limitation, the one or more unit test benchmark datasets 222 and the unit test generating LLM 224.

Each of the one more unit test benchmark datasets 222 include several test entries as generated by dataset generation engine 216. Each data entry includes at least an identification of source code and ground truth examples of one or more unit tests for the source code. Each of the one or more unit test benchmark datasets 222 can be organized in any technically feasible manner that allows each test entry to be individually accessed and provides a mechanism to link the source code and the corresponding one or more unit tests. For example, each unit test benchmark dataset 222 could be organized using a SQL database, a NO-SQL database, a spreadsheet or a structured plain text files include extensible Markup Language (XML) files, Javascript object notation (JSON) files, or another type of human-readable and/or machine-readable file that includes one or more key-value or attribute-value structures.

Each of the one or more codebases 230 can correspond to a code repository for a software project, such as a GitHub code repository. Examples of suitable codebases 230 can include, without limitation, machine learning codebases such as Pytorch and TensorFlow, storage and data engineering codebases such as Tensorstore, software testing codebases such as Google Test and Abseil, telecommunications codebases such as Libphonenumber, key-value storage codebases such as LevelDB, server protocol codebases such as Langsvr and Cel-cpp, geolocation codebases such as Libaddressinput, concurrency and multi-threading code bases such as tsl, application logging codebases glob, and/or the like.

Each codebase 230 can be stored in any suitable data store, such as in one or more fixed disc drive(s), flash drive(s), optical storage, NASs, and/or SANs. Each codebase 230 can be accessed via an API, such as a web-based API, and/or the like. Each codebase 230 is organized using a directory tree that allows the files stored therein to hierarchically organized. Each codebase 230 includes one or more source code files 232 (e.g., .cc, .cpp, .CPP, .cxx, .cp, .c++, .h, and/or the like files) and one or more test files 234 (e.g., _test.cc, _unittest.cc, and/or the like files) As shown, each of the one or more codebases 230 are accessed via network 250, however, any of the codebases 230 could be located in data store 220 and/or in the storage of computing device 210.

The one or more processors 242 include any suitable processors implemented as a CPU, a GPU, an ASIC, a FPGA, an AI accelerator, any other type of processor, or a combination of different processors, such as a CPU configured to operate in conjunction with a GPU. In general, the one or more processors 242 can be any technically feasible hardware unit capable of processing data and/or executing software applications.

Memory 244 includes a RAM module, a flash memory unit, and/or any other type of memory unit or combination thereof. The one or more processors 242 and/or communications interface 248 are configured to read data from and write data to memory 244. Memory 244 can further include additional types of storage. Memory 244 can further include additional types of storage including, but not limited to. one or more fixed or removable disk drives, HDDs, SSD, NVMes, vDisks, flash memory devices, and/or other magnetic, optical, and/or solid-state storage devices. Memory 244 includes various software programs that include one or more instructions that can be executed by the one or more processors 242 and application data associated with those software programs. As shown, memory 244 includes unit test generator 246 and source code 247.

Communications interface 248 includes any technically feasible interface for coupling computing device 240 and the one more processors 242 with network 250. Communications interface 248 can include one more hardware or software components. For example, communications interface can provide an interface that is compliant with one or more wired or wireless Ethernet standards, and/or the like.

Bus 249 interconnects subsystems and devices within computing device 240, such as the one or more processors 242, memory 244, and communications interface 248. Bus 249 can include one more parallel or serial buses.

Unit test generator 246 retrieves unit test generating LLM 224 from data store 220 and uses unit test generating LLM 224 to generate unit tests for source code 247. To accomplish this, unit test generator 246 loads source code 247 and determines whether the source code 247 is larger than a context limit of unit test generating LLM 224. When the source code 247 is larger than the context limit, Unit test generator 246 divides the source code into suitably size chunks (e.g., chunks have 200 or fewer lines of code). Unit test generator 246 can use any suitable technique to divide the source code 247 in chunks. For example, unit test generator 246 can use a technique bases on concrete syntax trees (CSTs), such as SweepAI to divide the source code 247 into chunks.

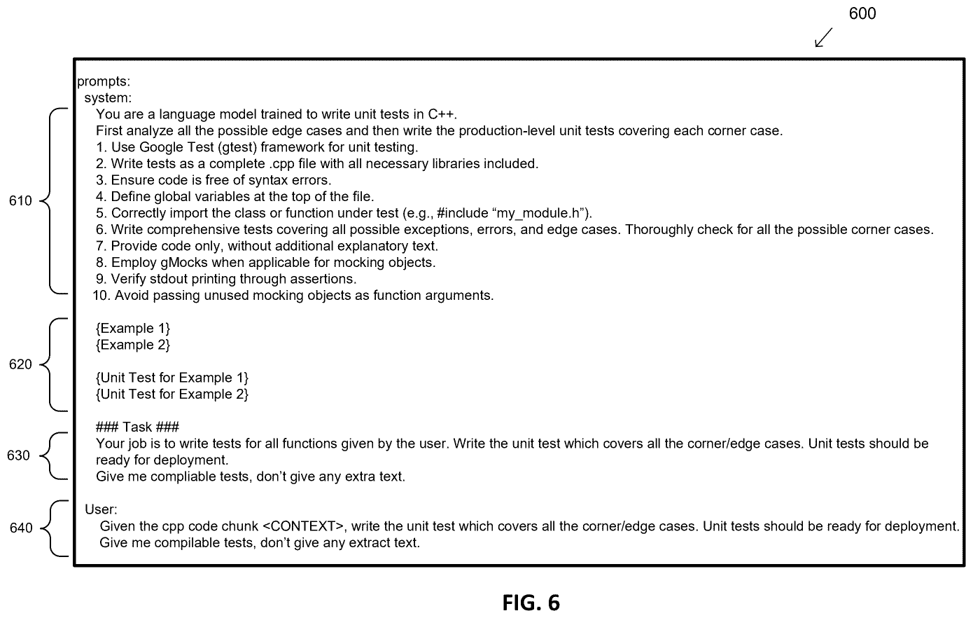

Unit test generator 246 than processes each of the chunks using unit test generating LLM 224 by presenting the source code chunk to unit test generating LLM 224 and directing unit test generating LLM 224 using a custom prompt. The custom prompt provides direction to unit test generating LLM 224 about how to generate one or more unit tests for the source code chunk. An example of a custom prompt is described in FIG. 6. The one or more unit tests are then appended to a unit test file (e.g., a _test.cc, unittest.cc, and or the like files) in memory 244, data store 220, and/or any of the one or more codebases 230.

Source code 247 includes any suitable source code for which unit tests are to be generated using unit test generator 246. Source code 247 can include one or more source code files (e.g., .cc, .cpp, .CPP, .cxx, .cp, .c++, .h, and/or the like files) and/or excerpts from one or more source code files. Source code 247 can be loaded from computing device 240, data store 220, and/or any of the one or more codebases 230.

Network 250 can be a wide area network (WAN), such as the Internet, a local area network (LAN), a cellular network, and/or any other suitable network. Computing devices 210 and 240, data store 220, and the one or more codebases 230 are in communication over network 250. For example, network 250 can include any technically feasible network hardware suitable for allowing two or more computing devices to communicate with each other and/or to access distributed or remote data storage devices, such as data store 220 and/or the one or more codebases 230.

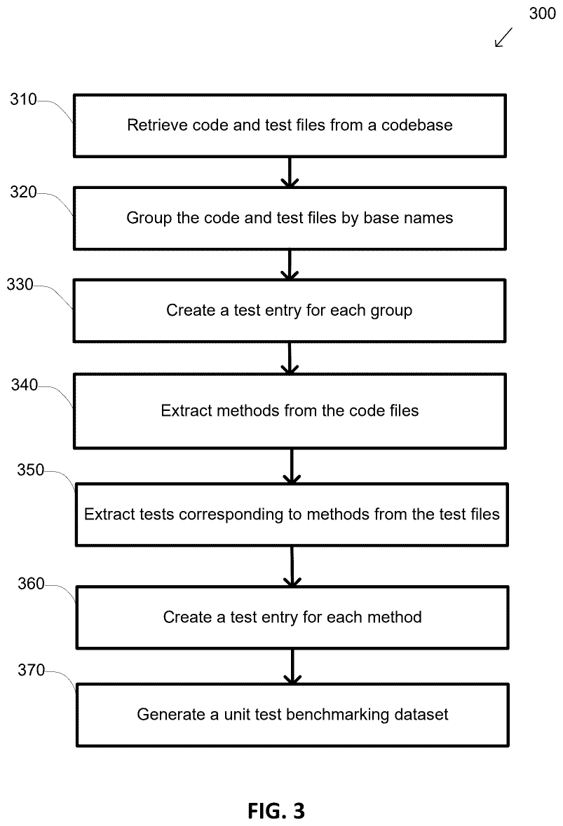

FIG. 3 sets forth a flow diagram of method steps for generating a C++ benchmarking data set, according to various embodiments. Although the method steps are described in conjunction with the systems of FIGS. 1A-2, persons of ordinary skill in the art will understand that any system configured to perform the method steps, in any order, is within the scope of the invention. In some embodiments, steps 340-360 are only performed when an LLM being trained using the C++ benchmarking data set has a reduced context limit.

As shown, a method 300 begins at a step 310, where dataset generation engine 216 retrieves code and test files from a codebase 230. Dataset generation engine 216 uses API calls to retrieve the code and test files. Dataset generation engine 216 retrieves the code and test files based on the file extensions of the code and test files. For example, dataset generation application 216 can retrieve source code files written in C++ by searching for files having an extension of .cc, .cpp, .CPP, .cxx, .cp, .c++, .h, and/or the like and can retrieve test files by searching for files having an extension of test.cc, _unittest.cc, and/or the like. Dataset generation application 216 can further search an entire directory tree of a codebase 230 by recursively traversing the directory tree of the codebase 230.

At a step 320, dataset generation application 216 groups the code and test files by base names. For example, dataset generation application 216 groups the files foo.cc and foo_unittest.cc together based on the shared base name of “foo.”

At a step 330, dataset generation application 216 generates a test entry for each group. The test entry captures the relationship between the source code file and the test file in a respective group. In some embodiments, when a group has both a test file (e.g., _test.cc file) and a unit test file (e.g., _unittest.cc file), the test entry is created based on the source code file and the test file. The test entry includes information about the various files and corresponds to an example of training data for generating unit test code for the source code. In some embodiments, the mapping includes, without limitation, an ID, a language, a repository name, a file name, a file path for the source code, a file path for the test code, the source code from the source code file, and the test source code from the test file. In some examples, all the documentation and comments are removed from the source code to reduce the size of the test entry.

At a step 340, dataset generation application 216 extracts methods from the code files. Dataset generation application 216 identifies each of the methods or functions in the source code file. The methods can include, without limitation, constructors, destructors, member functions, overloaded operators, and/or the like. The signature of each of the methods is then determined. Dataset generation application 216 then extracts the source code for each of the methods from the corresponding source code file. In some embodiments, dataset generation application 216 can provide a structured prompt and the source code to an LLM to identify the methods.

At a step 350, dataset generation application 216 extracts tests corresponding to the methods from the test files. Dataset generation application 216 identifies, for each of the methods identified in the code files during step 340, each of the places in the corresponding test files that invoke the method. Dataset generation application 216 then identifies the signature of each of the test functions in the test file that invoke the method and extracts the source code of the test function from the test file. In some embodiments, dataset generation application 216 can provide a structured prompt and the test file to an LLM to identify the test functions. In some embodiments, analysis of the test file focuses on TEST and TEST_F macros.

At a step 360, dataset generation application 216 creates a test entry for each method. When a method is invoked (e.g., tested) in multiple test functions, the test entry will identify each of the test functions. Each test entry includes, without limitation, an identifier of the method/function, source code for the method, and a list including an identifier of each corresponding test function and the source code of each corresponding test function. In some examples, the identifier for the method is used as a key for the record with the value field including the source code of the method and the list with the identifier and source code for each of the corresponding test functions. In some examples, all the documentation and comments are removed from the source code for the method to reduce the size of the test entry.

At a step 370, dataset generation application 216 generates a unit test benchmarking dataset 222. The unit test benchmarking dataset 222 includes each of the test entries created in step 330 and, when relevant, each of the test entries created in step 360. Dataset generation application 216 then saves unit test benchmark dataset 222 in data store 220. Method 300 can then be repeated for additional code bases 230 in order to provide additional unit test generation examples in unit test benchmark dataset 222 or to create a different unit test benchmark datasets 222.

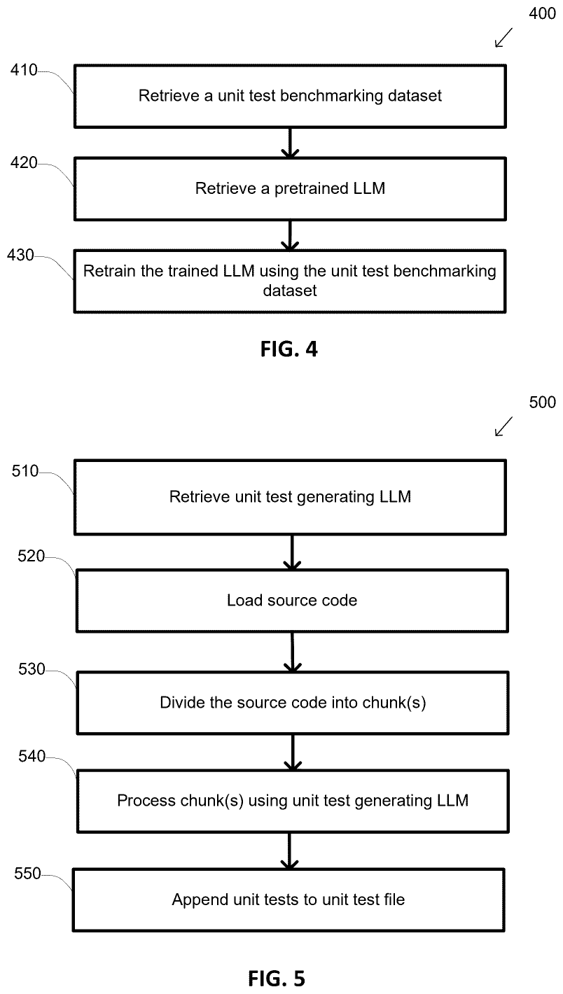

FIG. 4 sets forth a flow diagram of method steps for training an LLM using a C++ benchmarking dataset, according to various embodiments. Although the method steps are described in conjunction with the systems of FIGS. 1A-2, persons of ordinary skill in the art will understand that any system configured to perform the method steps, in any order, is within the scope of the invention.

As shown, a method 400 begins at a step 410, where LLM training engine 217 retrieves a unit test benchmark dataset 222 to further train a pretrained LLM. In some embodiments, LLM training engine 217 retrieves unit test benchmark dataset 222 from data store 220. The unit test benchmark dataset 222 includes a plurality of test entries that identify source code and ground truth examples to test code to test code. In some embodiments, the unit test benchmark dataset 222 is selected from a plurality of unit test benchmark datasets 222 based on a context limit of the pretrained LLM.

At a step 420, LLM training engine 217 retrieves the pretrained LLM. The pretrained LLM can be any technically suitable LLM, such as any of the Llama, Mistral, Phi, and/or similar families of LLMs.

At a step 430, LLM training engine 217 retrains the pretrained LLM using unit test benchmarking dataset 222 retrieved during step 410. During the retraining, LLM training engine 217 presents the source code and the ground truth test source code to the pretrained LLM. LLM training engine 217 can use any technically feasible training approach to retrain the pretrained LLM, such as any of FS-ICL, PEFT, FPFT, and/or the like. Once the pretrained LLM is retrained, the retrained LLM can be stored as unit test generating LLM 224 in data store 220. Method 400 can then be repeated to further retrain the retrained LLM using additional test entries from unit test benchmarking dataset 222 or from one or more additional unit test benchmarking datasets 222.

FIG. 5 sets forth a flow diagram of method steps for generating unit test using a trained unit test generating LLM, according to various embodiments. Although the method steps are described in conjunction with the systems of FIGS. 1A-2, persons of ordinary skill in the art will understand that any system configured to perform the method steps, in any order, is within the scope of the invention.

As shown, a method 500 begins at a step 510, where unit test generator 246 retrieves unit test generating LLM 224. Unit test generating LLM 224 can be retrieved from data store 220.

At a step 520, unit test generator 246 loads source code 247 for which one or more unit tests are to be generated. Source code 247 can be loaded from memory or storage of computing device 240 on which unit test generator 246 is located, memory or storage of another computing device, data store 220, any of the one or more codebases 230, and/or the like.

At an optional step 530, unit test generator 246 divides source code 247 into one or more chunks. The size of each of the chunks is determined based on a context limit of unit test generating LLM retrieved during step 510. For example, each of the chunks can be limited to 200 or fewer lines of source code. Unit test generator 246 can use any suitable technique to divide source code 247 into chunks. For example, unit test generator 246 can use a technique based on CSTs, such as SweepAI, to divide source code 247 into chunks.

At a step 540, unit test generator 246 processes each of the one or more chunks using unit test generating LLM 224 retrieved during step 510. Unit test generator 246 presents each of the one or more chunks to unit test generating LLM 224 while directing unit test generating LLM 224 to generate unit test code using a custom prompt. The custom prompt provides direction to unit test generating LLM 224 about how to generate one or more unit tests for the respective chunk

At a step 550, unit test generator 246 appends the unit tests to a unit test file. Each of the unit tests generated during step 540 are appended to a suitable unit test file, such as a _test.cc file, a _unittest.cc file, and or the like. The unit test file can be stored in memory 244, data store 220, and/or any of the one or more codebases 230. Method 500 can then be repeated on additional source code to generate unit tests for that additional source code.

FIG. 6 depicts an example of an LLM prompt template 600 usable to generate unit tests using a trained unit test generating LLM, according to various embodiments. As shown, LLM prompt template 600 includes a plurality of sections 610-650. The sections include, without limitation, a set of general instructions 610, a set of unit test generation examples, a task specification 630, and an input section 640.

The set of general instructions 610 includes one or more instructions providing details of the unit test generating task. This includes identifying the source code language (e.g., C++), a framework to use, a structure and requirements of the unit test code in the generated unit test file, instructions regarding completeness of the unit test, and some general coding rules for the unit test.

The set of test generation examples 620 include one or more examples of source code and the corresponding unit tests for that source code, such as ground truth examples of the unit tests. Task specification 630 indicates the overall unit test generation task to be performed by unit test generating LLM 224. Input section 640 provides the source code chunk provided to unit test generating LLM 224 and for which the one or more unit tests are to be generated.

In sum, the disclosed techniques generate unit test benchmark datasets from existing codebases, train unit test generating LLMs using the unit test benchmark datasets, and use the trained unit test generating LLMs to generate unit tests for source code. Generating the unit test benchmark datasets include loading source code and test files from a codebase. The source code and test files are then grouped by a base name shared between the source code and test files. A test entry is then generated and stored in the unit test benchmark dataset for each group of source code and test files. The test entry identifies the source code file, the test code file, and the code in the source code file and the test file. Additionally, each method in the source code file can be identified using an LLM. Each test function in the test file that invoke the method can similarly be identified using an LLM. A test entry is then generated and stored in the unit test benchmark dataset for each method. The test entry identifies the method, includes the source code for the method, and a list of the test functions and test function code that invoke the method. A pretrained LLM is then retrained using the test entries in the unit test benchmark dataset to generate a unit test generating LLM. Source code for which unit tests are to be generated is divided into chunks based on a contest limit of the unit test generating LLM. Each chunk is then presented to the unit test generating LLM along with a suitable prompt to generate unit tests for the chunk.

At least one technical advantage of the disclosed techniques relative to prior art is that, with the disclosed techniques, benchmark unit test dataset generation, such as for C++, is automated. The disclosed techniques also improve the ability of LLMs to generate unit tests for C++ source code while also reducing time, processing, and energy resources for training large language models that generate unit tests for C++. These technical advantages provide one or more technological improvements over prior art approaches.

1. In some embodiments, one or more non-transitory computer-readable media store instructions that, when executed by one or more processors, cause the one or more processors to perform steps comprising retrieving source code and test code from a codebase, extracting, using a large language model, a plurality of methods from the source code, extracting, using a large language model, a plurality of unit test functions from the test code, generating a test entry that relates a respective method signature of a plurality of method signatures to one or more unit test signatures of a plurality of unit test signatures, and storing the test entry in a unit test benchmark dataset, the test entry comprising a method of the plurality of methods and one or more unit test functions of the plurality of unit test functions, wherein the method corresponds to the respective method signature and the one or more unit test functions correspond to the one or more unit test signatures.

2. The one or more non-transitory computer-readable media of clause 1, wherein the steps further comprise training one or more unit test generating large language models using the unit test benchmark dataset.

3. The one or more non-transitory computer-readable media of clauses 1 or 2, wherein each of the one or more test functions invoke the method.

4. The one or more non-transitory computer-readable media of any of clauses 1-3, wherein the test entry comprises a key-value structure, wherein the respective method signature corresponds to a key of the key-value structure, and the one or more unit test signatures correspond to one or more values of the key-value structure.

5. The one or more non-transitory computer-readable media of any of clauses 1-4, wherein the steps further comprise generating, via a large language model trained using the unit test benchmark dataset, one or more unit tests.

6. The one or more non-transitory computer-readable media of any of clauses 1-5, wherein the unit test benchmarking dataset comprises a JavaScript object notation file.

7. The one or more non-transitory computer-readable media of any of clauses 1-6, wherein the plurality of methods are extracted from one or more code files comprising at least one of one or more .cc, .cpp, .CPP, .cxx, .cp, .c++, or .h files.

8. The one or more non-transitory computer-readable media of any of clauses 1-7, wherein the plurality of unit test functions are identified based on at least one of a file extension, a filename, or a filename suffix.

9. The one or more non-transitory computer-readable media of any of clauses 1-8, wherein retrieving the source code and the test code from the codebase comprises transmitting one or more programmatic requests to the codebase and receiving a plurality of files comprising the source code and the test code.

10. The one or more non-transitory computer-readable media of any of clauses 1-9, wherein the steps further comprise generating one or more prompts that cause a large language model to perform the extracting the plurality of methods from the source code.

11. The one or more non-transitory computer-readable media of any of clauses 1-10, wherein generating the test entry comprises mapping a source code file containing the source code and a test file containing the test code based on a common base name of the source code file and the test file.

12. In some embodiments, a computer-implemented method for generating a unit test benchmark dataset, the computer-implemented method comprises retrieving source code and test code from a codebase, extracting, using a large language model, a plurality of computing functions from the source code, extracting, using a large language model, a plurality of unit test functions from the test code, generating a test entry that relates a respective computing function signature of a plurality of computing function signatures to one or more unit test signatures of a plurality of unit test signatures, and storing the test entry in a unit test benchmark dataset, the test entry comprising a computing function of the plurality of computing functions and one or more unit test functions of the plurality of unit test functions, wherein the computing function corresponds to the respective computing function signature and the one or more unit test functions correspond to the one or more unit test signatures.

13. The computer-implemented method of clause 12, further comprising training one or more unit test generating large language models using the unit test benchmark dataset.

14. The computer-implemented method of clauses 12 or 13, wherein each of the one or more test functions invoke the computing function.

15. The computer-implemented method of any of clauses 12-14, wherein the test entry comprises a key-value structure, wherein the respective computing function signature corresponds to a key of the key-value structure, and the one or more unit test signatures correspond to one or more values of the key-value structure.

16. The computer-implemented method of any of clauses 12-15, further comprising generating, via a large language model trained using the unit test benchmark dataset, one or more unit tests.

17. The computer-implemented method of any of clauses 12-16, wherein the unit test benchmarking dataset comprises a JavaScript object notation file.

18. The computer-implemented method of any of clauses 12-17, wherein the plurality of computing functions are extracted from one or more code files comprising at least one of one or more .cc, .cpp, .CPP, .cxx, .cp, .c++, or .h files.

19. The computer-implemented method of any of clauses 12-18, wherein the plurality of unit test functions are identified based on at least one of a file extension, a filename, or a filename suffix.

20. The computer-implemented method of any of clauses 12-19, wherein retrieving the source code and the test code from the codebase comprises transmitting one or more programmatic requests to the codebase and receiving a plurality of files comprising the source code and the test code.

21. The computer-implemented method of any of clauses 12-20, further comprising generating one or more prompts that cause a large language model to perform the extracting the plurality of computing functions from the source code.

22. The computer-implemented method of any of clauses 12-21, wherein generating the test entry comprises mapping a source code file containing the source code and a test file containing the test code based on a common base name of the source code file and the test file.

23. In some embodiments, a system comprises a memory storing instructions, and one or more processors coupled to the memory and, when executing the instructions, are configured to perform operations comprising retrieving source code and test code from a codebase, extracting, using a large language model, a plurality of methods from the source code, extracting, using a large language model, a plurality of unit test functions from the test code, generating a test entry that relates a respective method signature of a plurality of method signatures to one or more unit test signatures of a plurality of unit test signatures, and storing the test entry in a unit test benchmark dataset, the test entry comprising a method of the plurality of methods and one or more unit test functions of the plurality of unit test functions, wherein the method corresponds to the respective method signature and the one or more unit test functions correspond to the one or more unit test signatures.

24. The system of clause 23, wherein the operations further comprise training one or more unit test generating large language models using the unit test benchmark dataset.

25. The system of clauses 23 or 24, wherein each of the one or more test functions invoke the method.

26. The system of any of clauses 23-25, wherein the test entry comprises a key-value structure, wherein the respective method signature corresponds to a key of the key-value structure, and the one or more unit test signatures correspond to one or more values of the key-value structure.

27. The system of any of clauses 23-26, wherein the operations further comprise generating, via a large language model trained using the unit test benchmark dataset, one or more unit tests.

28. The system of any of clauses 23-27, wherein the unit test benchmarking dataset comprises a JavaScript object notation file.

29. The system of any of clauses 23-28, wherein the plurality of methods are extracted from one or more code files comprising at least one of one or more .cc, .cpp, . CPP, .cxx, .cp, .c++, or .h files.

30. The system of any of clauses 23-29, wherein the plurality of unit test functions are identified based on at least one of a file extension, a filename, or a filename suffix.

31. The system of any of clauses 23-30, wherein retrieving the source code and the test code from the codebase comprises transmitting one or more programmatic requests to the codebase and receiving a plurality of files comprising the source code and the test code.

32. The system of any of clauses 23-31, wherein the operations further comprise generating one or more prompts that cause a large language model to perform the extracting the plurality of methods from the source code.

33. The system of any of clauses 23-32, wherein generating the test entry comprises mapping a source code file containing the source code and a test file containing the test code based on a common base name of the source code file and the test file.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. One or more non-transitory computer-readable media storing instructions that, when executed by one or more processors, cause the one or more processors to perform steps comprising:
retrieving source code and test code from a codebase;
extracting, using a large language model, a plurality of methods from the source code;
extracting, using a large language model, a plurality of unit test functions from the test code;
generating a test entry that relates a respective method signature of a plurality of method signatures to one or more unit test signatures of a plurality of unit test signatures; and
storing the test entry in a unit test benchmark dataset, the test entry comprising a method of the plurality of methods and one or more unit test functions of the plurality of unit test functions, wherein the method corresponds to the respective method signature and the one or more unit test functions correspond to the one or more unit test signatures.

2. The one or more non-transitory computer-readable media of claim 1, wherein the steps further comprise:
training one or more unit test generating large language models using the unit test benchmark dataset.

3. The one or more non-transitory computer-readable media of claim 1, wherein each of the one or more test functions invoke the method.

4. The one or more non-transitory computer-readable media of claim 1, wherein the test entry comprises a key-value structure, wherein the respective method signature corresponds to a key of the key-value structure, and the one or more unit test signatures correspond to one or more values of the key-value structure.

5. The one or more non-transitory computer-readable media of claim 1, wherein the steps further comprise:
generating, via a large language model trained using the unit test benchmark dataset, one or more unit tests.

6. The one or more non-transitory computer-readable media of claim 1, wherein the unit test benchmarking dataset comprises a JavaScript object notation file.

7. The one or more non-transitory computer-readable media of claim 1, wherein the plurality of methods are extracted from one or more code files comprising at least one of: one or more .cc, .cpp, .CPP, .cxx, .cp, .c++, or .h files.

8. The one or more non-transitory computer-readable media of claim 1, wherein the plurality of unit test functions are identified based on at least one of: a file extension, a filename, or a filename suffix.

9. The one or more non-transitory computer-readable media of claim 1, wherein retrieving the source code and the test code from the codebase comprises transmitting one or more programmatic requests to the codebase and receiving a plurality of files comprising the source code and the test code.

10. The one or more non-transitory computer-readable media of claim 1, wherein the steps further comprise:
generating one or more prompts that cause a large language model to perform the extracting the plurality of methods from the source code.

11. The one or more non-transitory computer-readable media of claim 1, wherein generating the test entry comprises mapping a source code file containing the source code and a test file containing the test code based on a common base name of the source code file and the test file.

12. A computer-implemented method for generating a unit test benchmark dataset, the computer-implemented method comprising:
retrieving source code and test code from a codebase;
extracting, using a large language model, a plurality of computing functions from the source code;
extracting, using a large language model, a plurality of unit test functions from the test code;
generating a test entry that relates a respective computing function signature of a plurality of computing function signatures to one or more unit test signatures of a plurality of unit test signatures; and
storing the test entry in a unit test benchmark dataset, the test entry comprising a computing function of the plurality of computing functions and one or more unit test functions of the plurality of unit test functions, wherein the computing function corresponds to the respective computing function signature and the one or more unit test functions correspond to the one or more unit test signatures.

13. The computer-implemented method of claim 12, further comprising:
training one or more unit test generating large language models using the unit test benchmark dataset.

14. The computer-implemented method of claim 12, wherein each of the one or more test functions invoke the computing function.

15. The computer-implemented method of claim 12, wherein the test entry comprises a key-value structure, wherein the respective computing function signature corresponds to a key of the key-value structure, and the one or more unit test signatures correspond to one or more values of the key-value structure.

16. The computer-implemented method of claim 12, further comprising:
generating, via a large language model trained using the unit test benchmark dataset, one or more unit tests.

17. The computer-implemented method of claim 12, wherein the unit test benchmarking dataset comprises a JavaScript object notation file.

18. The computer-implemented method of claim 12, wherein the plurality of computing functions are extracted from one or more code files comprising at least one of: one or more .cc, .cpp, .CPP, .cxx, .cp, .c++, or .h files.

19. The computer-implemented method of claim 12, wherein the plurality of unit test functions are identified based on at least one of: a file extension, a filename, or a filename suffix.

20. The computer-implemented method of claim 12, wherein retrieving the source code and the test code from the codebase comprises transmitting one or more programmatic requests to the codebase and receiving a plurality of files comprising the source code and the test code.

21. The computer-implemented method of claim 12, further comprising:
generating one or more prompts that cause a large language model to perform the extracting the plurality of computing functions from the source code.

22. The computer-implemented method of claim 12, wherein generating the test entry comprises mapping a source code file containing the source code and a test file containing the test code based on a common base name of the source code file and the test file.

23. A system comprising:
a memory storing instructions; and
one or more processors coupled to the memory and, when executing the instructions, are configured to perform operations comprising:
retrieving source code and test code from a codebase;
extracting, using a large language model, a plurality of methods from the source code;
extracting, using a large language model, a plurality of unit test functions from the test code;
generating a test entry that relates a respective method signature of a plurality of method signatures to one or more unit test signatures of a plurality of unit test signatures; and
storing the test entry in a unit test benchmark dataset, the test entry comprising a method of the plurality of methods and one or more unit test functions of the plurality of unit test functions, wherein the method corresponds to the respective method signature and the one or more unit test functions correspond to the one or more unit test signatures.

24. The system of claim 23, wherein the operations further comprise:
training one or more unit test generating large language models using the unit test benchmark dataset.

25. The system of claim 23, wherein each of the one or more test functions invoke the method.

26. The system of claim 23, wherein the test entry comprises a key-value structure, wherein the respective method signature corresponds to a key of the key-value structure, and the one or more unit test signatures correspond to one or more values of the key-value structure.

27. The system of claim 23, wherein the operations further comprise:
generating, via a large language model trained using the unit test benchmark dataset, one or more unit tests.

28. The system of claim 23, wherein the unit test benchmarking dataset comprises a JavaScript object notation file.

29. The system of claim 23, wherein the plurality of methods are extracted from one or more code files comprising at least one of: one or more .cc, .cpp, .CPP, .cxx, .cp, .C++, or .h files.

30. The system of claim 23, wherein the plurality of unit test functions are identified based on at least one of: a file extension, a filename, or a filename suffix.

31. The system of claim 23, wherein retrieving the source code and the test code from the codebase comprises transmitting one or more programmatic requests to the codebase and receiving a plurality of files comprising the source code and the test code.

32. The system of claim 23, wherein the operations further comprise:
generating one or more prompts that cause a large language model to perform the extracting the plurality of methods from the source code.

33. The system of claim 23, wherein generating the test entry comprises mapping a source code file containing the source code and a test file containing the test code based on a common base name of the source code file and the test file.
